(19) United States
(12) Patent Application Publication
(10) Pub. No.: US 2010/0318516 A1
(43) Pub. Date: Dec. 16, 2010

(54) PRODUCTIVE DISTRIBUTION FOR RESULT OPTIMIZATION WITHIN A HIERARCHICAL ARCHITECTURE

(75) Inventors: John Kolen, Niceville, FL (US); Kacper Nowicki, Warsaw (PL); Nadav Eiron, San Jose, CA (US); Viktor Przebinda, Los Altos, CA (US); William Neveitt, Cupertino, CA (US); Cos Nicolaou, Palo Alto, CA (US)

Correspondence Address: BRAKE HUGHES BELLERMANN LLP;c/o CPA Global, PO Box 52050, Minneapolis, MN, 55402, US

(73) Assignee: GOOGLE INC., Mountain View, CA (US)

(21) Appl. No.: 12/609,788

(22) Filed: Oct. 30, 2009

Related U.S. Application Data
(60) Provisional application No. 61/185,978, filed on Jun. 10, 2009.

(51) Int. Cl. G06F 17/30; G06F 15/18; G06N 5/02

(52) U.S. Cl. 707/736; 707/E17.032; 707/E17.033; 706/12; 706/46; 707/770

(57) ABSTRACT

A producer node may be included in a hierarchical, tree-shaped processing architecture, the architecture including at least one distributor node configured to distribute queries within the architecture, including distribution to the producer node and at least one other producer node within a predefined subset of producer nodes. The distributor node may be further configured to receive results from the producer node and results from the at least one other producer node and to output compiled results therefrom. The producer node may include a query pre-processor configured to process a query received from the distributor node to obtain a query representation using query features compatible with searching a producer index associated with the producer node to thereby obtain the results from the producer node, and a query classifier configured to input the query representation and output a prediction, based thereon, as to whether processing of the query by the at least one other producer node within the predefined subset of producer nodes will cause results of the at least one other producer node to be included within the compiled results.

### CROSS REFERENCE TO RELATED APPLICATION

This application claims priority under 35 U.S.C. §119(e) to U.S. Provisional Patent Application 61/185,978, filed Jun. 10, 2009, titled “PRODUCTIVE DISTRIBUTION FOR RESULT OPTIMIZATION WITHIN A HIERARCHICAL ARCHITECTURE,” which is incorporated herein by reference in its entirety.

### TECHNICAL FIELD

This description relates to job distribution within a hierarchical architecture of a computer network.

### BACKGROUND

Conventional systems for data retrieval and processing attempt to optimize features such as accuracy and timeliness of result production, usage of computing resources, and further attempt to minimize user knowledge of, and interaction with, the system. There are various challenges associated with such attempts.

For example, in data retrieval, it is theoretically possible to store all necessary data at a location close to potential users of the data, so that the potential users will have proximate (and therefore timely) access to the most accurate data. In many systems, however, it may occur that users are distributed, and that a size of the data (combined with the distribution of the users) precludes its storage in any single location. Moreover, data of a certain size becomes difficult to search in an accurate and timely manner, and computing resources may experience a bottleneck if the data is over-consolidated.

Consequently, in many systems, data (and processing thereof) may be distributed in a manner that reflects the above difficulties. For example, by distributing certain types or subsets of the data to different geographic locations, access of the distributed users may be facilitated, and computing resources may be allocated more efficiently. In particular, such distribution systems may rely on a hierarchical or tree-based architecture that provides for data distribution in a structured and organized manner.

Such distributed systems, however, generally have associated difficulties of their own. For example, such distributed systems generally introduce additional latency, since, e.g., queries and results must be communicated across a network. Further, such distributed systems may structure the distribution of data such that smaller, faster databases are replicated in more/different locations, and therefore accessed sooner and more regularly, than larger, slower databases. More generally, such distributed systems may have some resources which are relatively more costly to access as compared to other resources. In this sense, such costs may refer to a cost in time, money, computing resources, or any limited resource within (or associated with) the system in question. As a result, it may be difficult to manage such costs within the larger context of optimizing results obtained from the system.

### SUMMARY

According to one general aspect, a producer node may be included in a hierarchical, tree-shaped processing architecture, the architecture including at least one distributor node configured to distribute queries within the architecture, including distribution to the producer node and at least one other producer node within a predefined subset of producer nodes. The distributor node may be further configured to receive results from the producer node and results from the at least one other producer node and to output compiled results therefrom. The producer node may include a query pre-processor configured to process a query received from the distributor node to obtain a query representation using query features compatible with searching a producer index associated with the producer node to thereby obtain the results from the producer node, and a query classifier configured to input the query representation and output a prediction, based thereon, as to whether processing of the query by the at least one other producer node within the predefined subset of producer nodes will cause results of the at least one other producer node to be included within the compiled results.

According to another general aspect, a computer-implemented method in which at least one processor implements at least the following operations may include receiving a query at a producer node from at least one distributor node within a hierarchical, tree-shaped processing architecture, the architecture including the at least one distributor node configured to distribute queries within the architecture, including distribution to the producer node and at least one other producer node, the distributor node being further configured to receive results from the producer node and results from the at least one other producer node and to output compiled results therefrom. The method may include pre-processing the query received from the distributor node to obtain a query representation using query features compatible with searching a producer index associated with the producer node to thereby obtain the results from the producer node, and classifying the query using the query representation to thereby output a prediction, based thereon, as to whether processing of the query by the at least one other producer node will cause results of the at least one other producer node to be included within the compiled results.

According to another general aspect, a computer program product may be tangibly embodied on a computer-readable medium and may include executable code that, when executed, is configured to cause a data processing apparatus to receive a query at a producer node from at least one distributor node within a hierarchical, tree-shaped processing architecture, the architecture including the at least one distributor node configured to distribute queries within the architecture, including distribution to the producer node and at least one other producer node, the distributor node being further configured to receive results from the producer node and results from the at least one other producer node and to output compiled results therefrom, pre-process the query received from the distributor node to obtain a query representation using query features compatible with searching a producer index associated with the producer node to thereby obtain the results from the producer node, and classify the query using the query representation to thereby output a prediction, based thereon, as to whether processing of the query by the at least one other producer node will cause results of the at least one other producer node to be included within the compiled results.

The details of one or more implementations are set forth in the accompanying drawings and the description below. Other features will be apparent from the description and drawings, and from the claims.

### BRIEF DESCRIPTION OF THE DRAWINGS

FIG. 1A is a block diagram of a system for productive distribution for result optimization within a hierarchical architecture.

FIG. 1B is a flowchart illustrating example operations of the system of FIG. 1A.

FIG. 2 is a flowchart illustrating example operations of the producer node of FIG. 1A.

FIG. 3 is a flowchart illustrating additional example operations of the classification manager of the system of FIG. 1A.

FIGS. 4A-4C are tables illustrating classification data used to construct a classification model.

FIG. 5 is a block diagram of example computing environments in which the system of FIG. 1A may operate.

### DETAILED DESCRIPTION

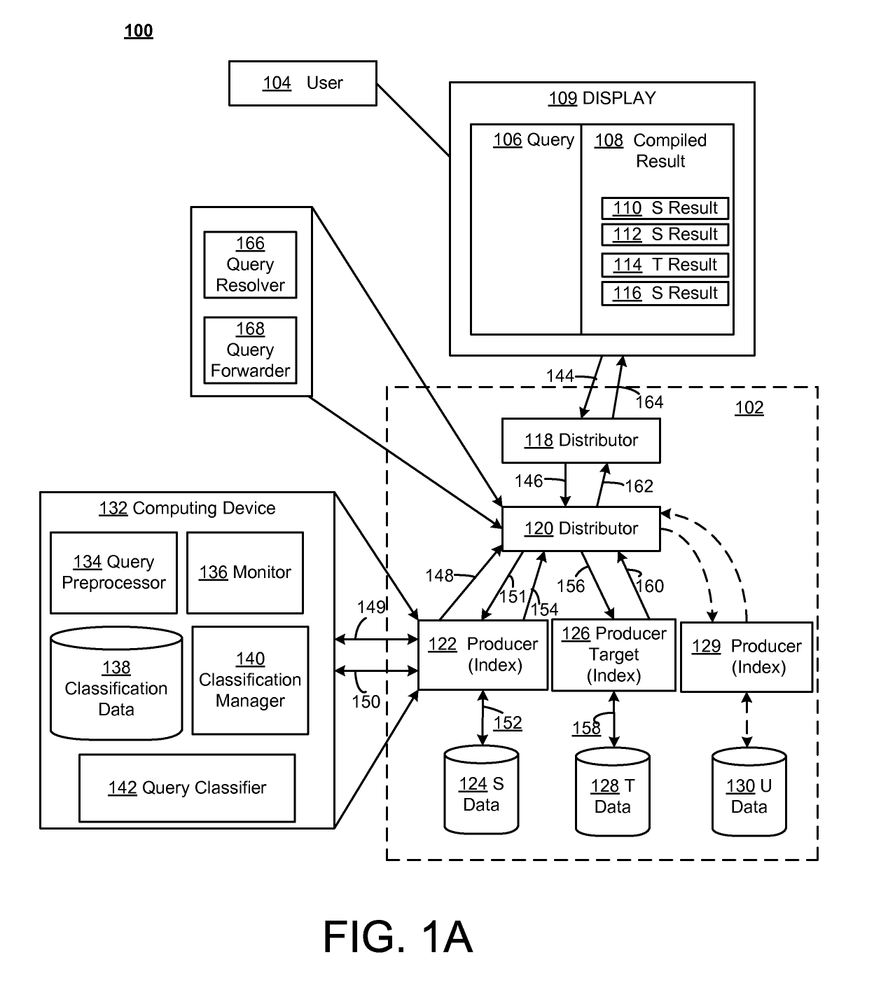

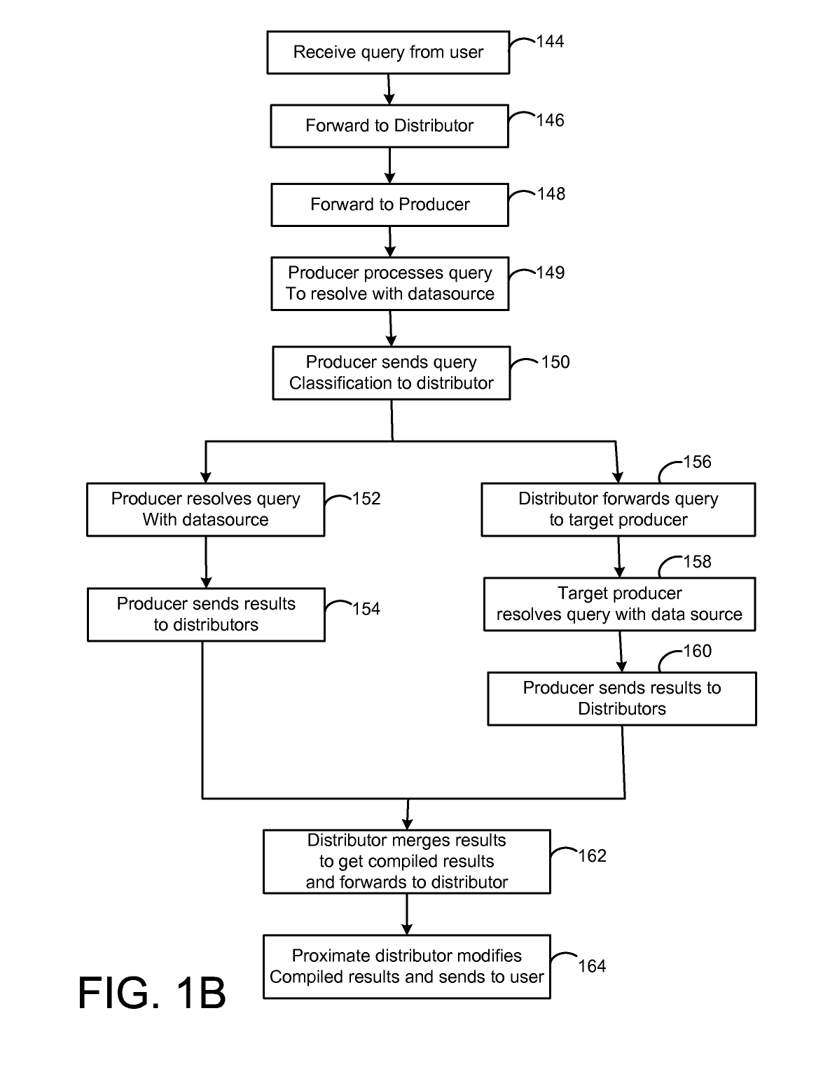

FIG. 1A is a block diagram of a system 100 for productive distribution for result optimization within a hierarchical architecture. In FIG. 1A, a hierarchical, tree-shaped architecture is illustrated to facilitate searches and other operations desired by a user 104. More specifically, the architecture 102 may accept a query 106 and return compiled results 108 to the user, and may do so in a manner that optimizes a usefulness/accuracy of the compiled results 108 while at the same time effectively managing resources of, and costs associated with, operations of the architecture 102.

In the example of FIG. 1A, it may be observed that the user 104 operates a display 109 on which a suitable graphical user interface (GUI) or other interface may be implemented so that the user may submit the query 106 and receive the compiled results 108 therewith. For example, the display 109 may represent any conventional monitor, projector, or other visual display, and a corresponding interface may include an Internet browser or other GUI. Of course, the display 109 may be associated with suitable computing resources (e.g., laptop computer, personal computer, or handheld computer), not specifically illustrated in FIG. 1A for the sake of clarity and conciseness. In example implementations, the user 104 and display 109 may be replaced by another computational system(s) that produces queries 106 and expects compiled results 108.

As referenced above, generally, speaking, the architecture 102 may include a number of possible data sources, as described in detail, below. Consequently, the compiled results 108 may include results from different ones of these data sources. In particular, as shown, compiled results 110, 112, 116 are associated with one data source (“S”) while compiled result(s) 114 is associated with another data source (“T”). It may be appreciated that with the plurality of available data sources within the architecture 102, neither the user 104 nor an operator of the architecture 102 may have specific knowledge, prior to accessing the architecture 102, as to which data source contains the various compiled results 110-116 and if the available results are of sufficient quality to appear in the compiled results 108.

In the architecture 102, a distributor node 118 and a distributor node 120 are illustrated which are configured to process queries and other job requests for forwarding to an appropriate producer node, e.g., one of producer node 122 (associated with a data source “S” 124), producer node 126 (associated with a data source “T” 128), and producer node 129 (associated with a data source “U” 130). The distributor node(s) 118, 120 also may be configured to receive returned results from one or more of the producer nodes 122, 126, 129 for compilation thereof into the compiled results 108. Thus, the architecture 102 represents a simplified example of the more general case in which a hierarchical, tree-shaped architecture includes a plurality of internal distributor nodes which distribute and collect queries within and among a plurality of leaf nodes that are producers of results of the query.

In FIG. 1A and throughout this description, the architecture 102 is discussed primarily with respect to queries for searching data sources 124, 128, 130. However, it may be appreciated that the term query in this context has a broader meaning, and may more generally be considered to represent virtually any job or task which may be suitable for distribution within a particular instance or subject matter of the described architecture 102. For example, such jobs may include report generation, calculations to be performed a task to be accomplished, or virtually any job for which the producer nodes 122, 126, 129 may produce results.

For purposes of the present description, then, it is assumed that the producers 122, 126, 129 may include, or be associated with, an index which is related to the corresponding data sources 124, 128, 130 and that mitigates or prevents a need to search within the actual content of documents of the data sources 124, 128, 130. In this regard, the term documents should be understood to refer to any discrete piece of data or data structure that may be stored within the data sources 124, 128, 130, and which, in the present examples, may be indexed in association with corresponding producer nodes 122, 126, 129 to facilitate searching of the documents.

That is, e.g., each such index may contain structured information about content(s) of documents within a corresponding data source, including, e.g., words or phrases within the documents, or meta-data characterizing the content (including audio, video, or graphical content). Examples of such indexing techniques are well known in the art and are not described further here except as necessary to facilitate understanding of the present description.

As referenced above, it may generally be the case that the data sources 124, 128, 130 are included within, and therefore compatible with other elements of, the architecture 102. That is, e.g., queries distributed throughout the architecture 102 may be used by the various distribution nodes 118 and producer nodes 122, 126, 128 to obtain results that will ultimately be compiled into the compiled results 108.

In so doing, however, it will be appreciated that, as already described, the different producer nodes 122, 126, 128 and associated data sources 124, 128, 130 may have significant differences in terms of a cost(s) associated with access thereof. For example, it may occur that the producer node 126 is geographically remote from the distributor node 120 and/or the producer node 122, thereby introducing an access latency associated with traversing an intervening network(s) to access the producer node 126. In another example, the producer node 128 may have limited capacity to respond to queries, and/or may be so large that that search times therefore may become unacceptably long (introducing a computational latency in responding). As yet another example, in some cases, there may be a literal financial cost associated with accessing a particular data source.

In order to mitigate these and related difficulties associated with an access cost of accessing certain producer nodes of the architecture 102, an operator of the architecture 102 may have general knowledge that some data (and associated data sources) may contain more-widely accessed and desired data, and should therefore be placed higher (and thus, be more easily and more frequently accessible) than other data sources (e.g., in the example of FIG. 1A, data source 124 may be thought to represent such a data source). Further, such data sources that may be more widely accessed and have more frequently-desired results may be structured to contain fewer possible total results, so as to be relatively fast and easy to update, access, and search. Conversely, other data sources, which may be much larger, more remote, or otherwise more costly to access, may be placed lower within the architecture 102 and therefore accessed less frequently. For example, in FIG. 1A, it may occur that producer node 126 and data source 128 are geographically remote, while the producer node 129 and data source 130 have limited capacity to respond to queries.

In such an architecture, it should be apparent that the query 106 may first be distributed to the producer node 122, as being the source that is most likely to contain desired query results, and/or most able to provide such results in a timely, cost-effective manner. Of course, the producer node 122 and the data source 124 may not, in fact, contain a complete or best set of results for the query 106. In such a scenario, one option is to wait to judge a quantity or quality of results obtained from the data source 124, and then, if deemed necessary, proceed to access one or more of the remaining producer nodes 126, 129.

In this option, however, it is difficult to tell whether such a quantity or quality of query results warrant(s) the cost and effort associated with such access of the producer node(s) 126, 129. In particular, to the extent that the distributor nodes 118, 120 are responsible for distributing (e.g., routing) queries within the architecture 102, it may be difficult for such distributor node(s) to have either the information or the computational resources to make intelligent decisions regarding which of the producer nodes 122, 126, 129 to select for forwarding the query 106 thereto. Such information may be local to one or more of the producer node(s) 122, 126, 129, and not readily available to, e.g., the distributor node 120. Consequently, it may be difficult for the distributor node 120 to determine whether distribution of the query 106 to, e.g., the producer node 126, would be useful with respect to the query 106 and the compiled results 108.

In this regard, and by way of terminology, a data source of the architecture 102 may be said to be productive when it returns query results that are contained within the compiled results 108. For example, in FIG. 1A, it may be appreciated that the presented compiled results 110-116 represent the best-available query results for the query 106. As shown and described, the result 114 is obtained from the data source 128, so that it may be said that the producer node 126 was productive with respect to the query 106 and the compiled results 108. If, hypothetically, the producer node 129 was accessed in providing the compiled results 108, then it would be observed that the data source 130 did not provide any results which, when ranked against results from the data source(s) 124, 128, were deemed worthy of inclusion within the compiled results, so that the producer node 129 would be considered to be non-productive with respect to the query 106 and the compiled results 108.

Using this terminology, it is apparent that any access of the producer nodes 126, 129 which does not return productive results for the query 106 may be considered to be a waste of resources and a possible inconvenience (e.g., due to computational and or access latency) to the user 104, since the user receives no benefit from such an access in exchange for the efforts needed to undertake the access. For example, it may occur that the data source 124 initially produces a large number of results, and it may be difficult to tell whether such results might be improved by accessing the producer(s) 126, 129; i.e., whether the results will be improved significantly, marginally, or not at all.

In the latter two cases of marginal or no improvement, as described, accessing the one or both of the producer(s) 126, 129 may generally constitute a poor use of resources. Moreover, in such scenarios, even in a situation in which access of the producer node 122 provides a strong indication that access of the secondary producer node(s) 126, 129 is necessary (e.g., such as when the producer node 122 provides very few or no results), and even when the results of such an access are productive, it still may be observed that a disadvantageous delay occurs between when the indication is made/provided and when the secondary producer node(s) 126, 129 is/are actually accessed and results obtained therefrom.

Consequently, in the system 100 of FIG. 1A, the producer node 122 is provided with the ability to proactively predict when access of the producer node(s) 126, 129 may be desirable (e.g., when such access is likely to be productive and result in productive results being obtained therefrom for inclusion in the compiled results 108). Moreover, in FIG. 1A, such predictions may be made before (and/or in conjunction with) access of the data source 124 by the producer node 122 itself. In this way, query processing by the producer nodes 122, 126, and/or 129 may proceed essentially in parallel, and, moreover, may be more likely to provide productive results from the producer node(s) 126, 129 and efficient use of resources within the architecture 102.

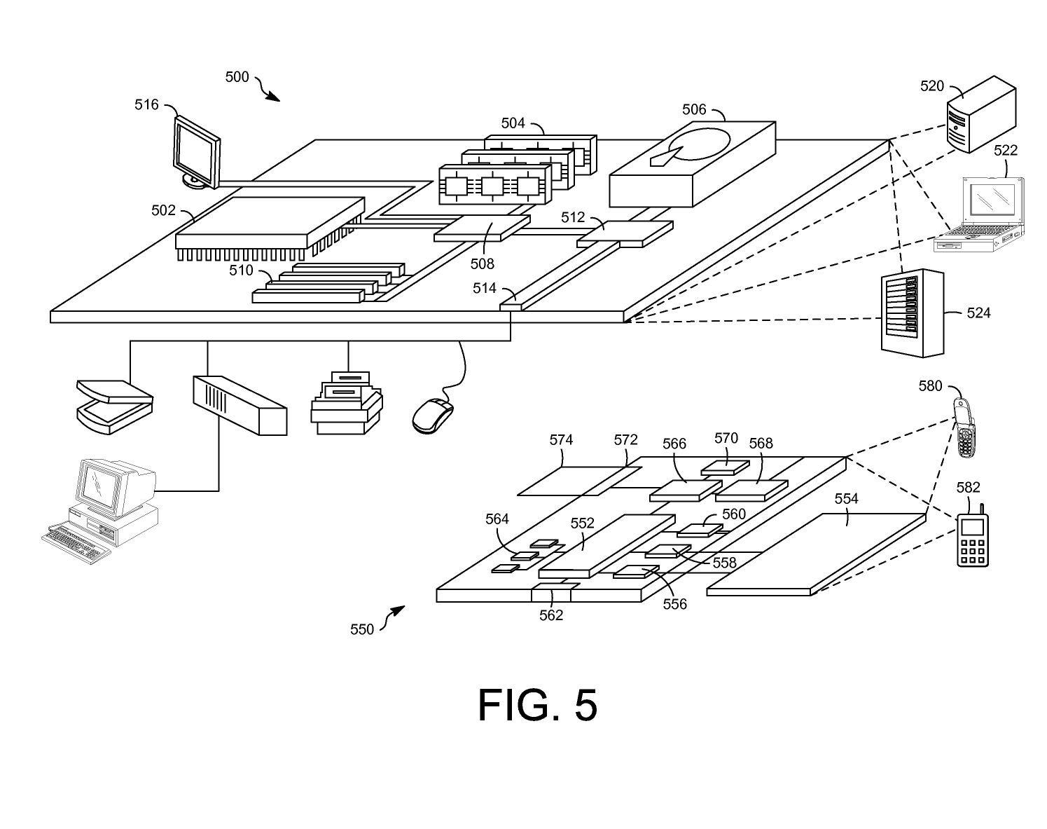

Specifically, as shown, the producer 122 may be executed using, or associated with, a computing device 132. It may be appreciated that the computing device 132 may be virtually any computing device suitable for performing the tasks described therein, such as described in more detail below with respect to FIG. 5.

In FIG. 1A, a query pre-processor 134 is illustrated which is configured to receive the query 106 and to prepare the query 106 for use with a corresponding index of the producer node 122 to thereby obtain results from the data source 124. Put another way, the query pre-processor 134 inputs the query and outputs a query representation which is a more complete and/or more compatible rendering of the query with respect to the producer node 122 (and associated index) and the data source 124.

Examples of such query pre-processing are generally known in the art and are not described here in detail except as needed to facilitate understanding of the description. In general, though, it may be appreciated that such query pre-processing may include an analysis of the query 106 to obtain a set of query features associated therewith. Merely by way of non-limiting example, some such query features may include, e.g., a length of the query (i.e., a number of characters), a number of terms in the query, a Boolean structure of the query, synonyms of one or more terms of the query, words with similar semantic meaning to that of terms in the query, words with similar spelling (or misspelling) to terms in the query, and/or a phrase analysis of the query.

In the latter regard, such phrase analysis may include, e.g., a length of each phrase(s), an analysis of which words are close to one another within the query, and/or may include an analysis of how often two or more words which are close within the query 106 tend to appear closely to one another in other settings (e.g., on the Internet at large). Such analysis may take into account particular topics or subject matter that may be deemed relevant to the query (e.g., corpus-specific knowledge, especially for specialized corpora containing particular types of result documents which might tend to include certain phrases or other word relationships). In other examples, such analysis may deliberately avoid consideration of such corpus-specific knowledge, and may consider the terms and their relation(s) to one another generically with respect to all available/eligible subject matter.

In general, such query-preprocessing may result in an increased likelihood that desired results from the data source 124 will be obtained for the user 104. For example, by including synonyms and potential misspellings of the query 106, the producer node 122 may obtain a relatively larger set of results from the data source 124. Then, when these results are sorted/filtered/ranked or otherwise processed, it may be more likely that the results provide a desired outcome than if the synonyms and misspellings were not included. In general, to the extent that processing times and/or computational resources are limited, it may be difficult or otherwise undesirable to consider all or even most of these query features, and (similarly) it may be desirable to limit an extent to which the query features are considered/implemented (e.g., it may be desirable to limit a number of synonyms included).

As described, conventional systems exist which utilize the general concepts of such query pre-processing in various ways and to various extents with respect to an index of the data source 124. In the example of FIG. 1A, the producer node 122 uses some or all of the results of such query pre-processing, not just for accessing the index of the data source 124, but also to make a classification of the query 106 which thereby provides a prediction as to whether it may be necessary or desirable to access the producer node(s) 126, 129 in conjunction with accessing the data source 124 (i.e., whether such access will be, or is likely to be, productive with respect to the compiled results 108). Then, using such a prediction, the distributor node 120 may be better-informed as to whether and when to access the producer node(s) 126, 129 with respect to the query 106.

Consequently, for example, such access, when it occurs, is more likely to be productive, and is less likely to occur when it would not be productive (and would therefore waste system resources and/or user time). Moreover, such access of the producer node(s) 126, 129 does not need to wait for access of the producer node 122 to complete before beginning, and may rather proceed essentially in parallel so that the compiled results 108 may be provided in an efficient and time-effective manner.

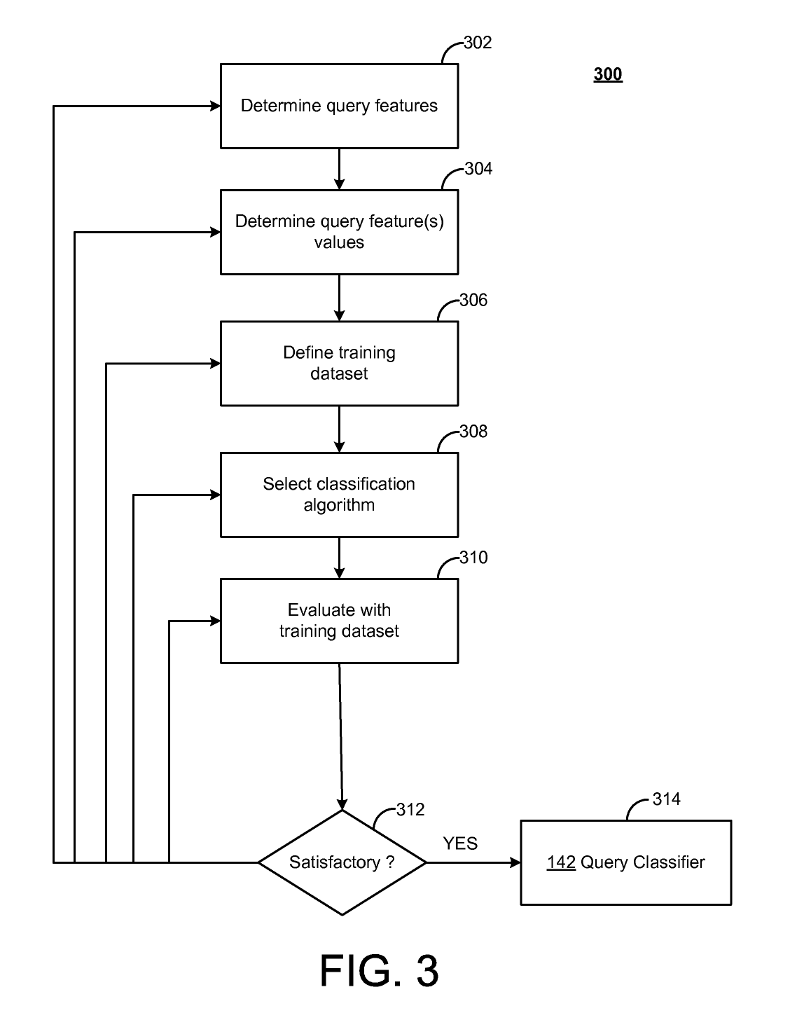

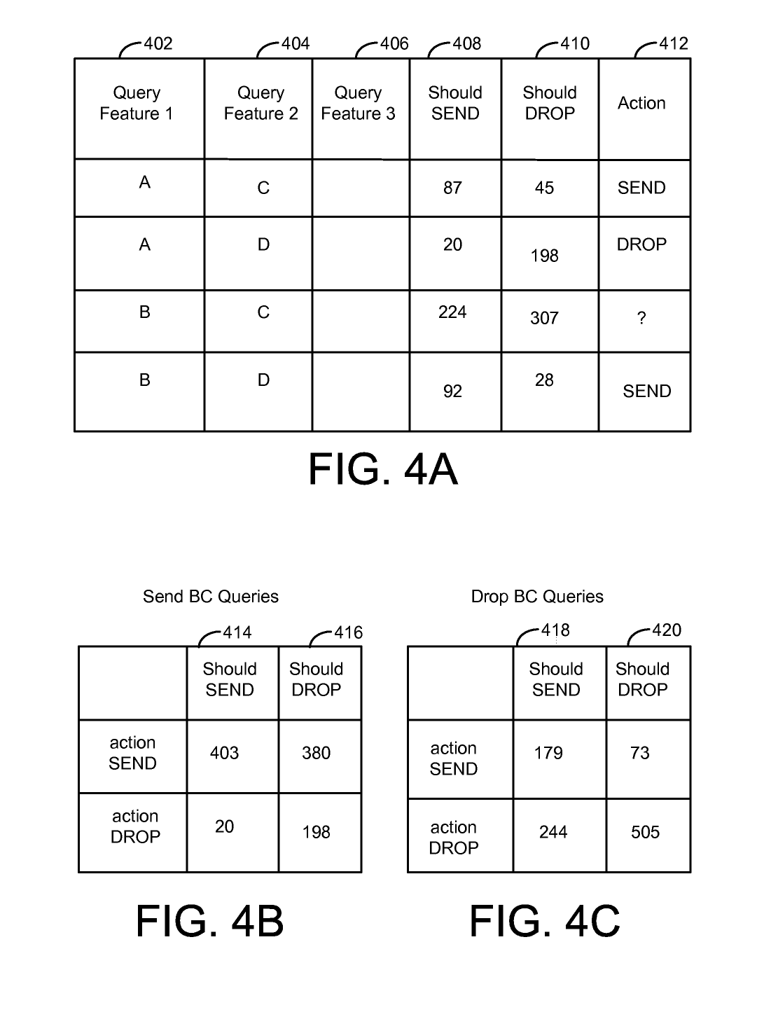

Specifically, in the example of FIG. 1A, a classification manager 140 is included which accesses classification data 138 to construct a model with which a query classifier 142 may make the above-referenced prediction about whether access of the producer node(s) 126, 129 will be productive with respect to the compiled results of the query 106. For example, as described in detail below with respect to FIGS. 3 and 4, the classification manager 140 may implement machine learning techniques in order to construct the classification model to be implemented by the query classifier 142.

In general, the classification manager 140 may operate by sending a relatively large number of queries received at the producer node 122 to one or more of the other producer nodes 126, 129. Then, a monitor 136 may be used to observe and track the results of such queries, and to report these results to the classification manager 140. Thus, the classification data 138 may include, e.g., a type or nature of various query features used by the query pre-processor, actual values for such query features for queries received at the producer node 122, and results tracked by the monitor 136 from one or more of the producer nodes 126, 129 with respect to the stored queries and query features (and values thereof).

The classification manager 140 may then construct a classification model (as described below with respect to FIGS. 3 and 4) to be output to, and used by, the query classifier 142. Then, at a later time when the query 106 is actually received by the producer node 122, the query classifier 142 may input a pre-processing of the query 106 from the query pre-processor 134, as well as the classification model from the classification manager 140, and may use this information to make a prediction about whether the query 106 should be sent to the producer node(s) 126, 129 (as being likely to be productive with respect to the compiled results 108) or should not be sent (as being likely to be unproductive and therefore potentially wasteful of computing resources and user time).

In this regard, it may be appreciated that, as already described, the query pre-processor considers some or all of the pre-defined query features and processes the query 106 accordingly for accessing the index of the data source 124 therewith. With regard to the query classifier 142 and the classification manager 140, which also use results of the query pre-processor 134, it may be said that the query pre-processor 134 provides a query representation of the query 106.

That is, such a query representation may be considered to be an expanded (or, in some cases, contracted) and/or analyzed version of the query 106 which contains data and meta-data related thereto, and related to the pre-defined query features. In some cases, such a query representation used by the classification manager 140/query classifier 142 may be the same query representation used by the index of the producer node 122 to access the data source 124. In other examples, the query representation used by the classification manager 140/query classifier 142 may be a different query representation than that used by the index of the producer node 122 to access the data source 124 (e.g., may use different subsets of the query features, and values thereof, to construct the classification model). In particular, the classification model may be updated over time to reflect a dynamic nature of the architecture 102 and contents thereof, and may therefore need or use different subset(s) of the query features in different embodiments of the classification model. On the other hand, a query representation used by the index of the producer node 122 to access the data source 124 may be relatively static or slower-changing, and may use a more constant set of the query features.

Thus, based on a query representation from the query pre-processor 134 and the classification model from the classification manager 140 (and associated data from the monitor 136 and/or the classification data 138), the query classifier 142 may make a classification of the query 106 which essentially provides a prediction as to whether distribution of the query 106 to, e.g., the producer node 126 would be productive with respect to the compiled results 108.

More specifically, the query classifier 142 may forward such a classification/prediction to the distributor node 120, which may then forward (or not) the query accordingly. In some example embodiments, the distributor node 120 may be configured to simply receive the prediction and forward the query 106 (or not) accordingly, using, e.g., a query forwarder 168. In other example embodiments, the distributor node 120 may be configured to make higher-level decisions regarding whether, when, and how to distribute the query 106 to other producer node(s).

In the latter regard, for example, the distributor node 120 may include a query resolver 166 that is configured to process a prediction from the query classifier 142 and to make an intelligent decision regarding the forwarding of the query 106 by the query forwarder 168. For example, in some example embodiments, the query classifier 142 may provide the classification of the query as a simple yes/no decision as to whether forwarding of the query 106 to the producer node 126 would be productive. In other embodiments, the query classifier 142 may provide the prediction as a value within a range, the range indicating a relative likelihood of whether the identified producer node(s) is likely to contain productive results (where, in some cases, the productive results likelihood may be further broken down into categories indicating an extent of predicted productivity, such as “highly productive” queries that are predicted to be within a first page or other highest set of compiled results 108).

Then, the query resolver 166 may input such information and whether, when, and how to distribute the query 106. For example, the query resolver 166 may weigh such factors as whether the network is currently congested, or how costly a particular access of a particular producer node with a particular query might be. Thus, the query resolver 166 may perform, e.g., essentially a cost-benefit analysis using the known/predicted cost(s) of accessing a given producer node as compared to the predicted likelihood and extent of usefulness of results obtained therefrom.

In FIG. 1A, the various components are illustrated as discrete elements at discrete/separate locations (e.g., different geographic locations and/or different network locations). For example, as just discussed, the query resolver 166 is illustrated as being co-located with the distributor node 120, since the distributor node 120 may be relatively well-positioned to be informed about current network conditions or other status information related to the architecture 102, and/or may be so informed regarding all producer nodes 122, 126, 129 which are underneath it within the hierarchy of the architecture 102. As a result, the query resolver 166 may be in a position to make the described decisions about whether, when, and how to forward the query 106. Similarly, the query pre-processor 134 and the query classifier 142 are illustrated as being contained within a single computing device 132 of the producer node 122.

In various practical implementations, however, many variations of FIG. 1A are possible. In particular, the various described functionalities may each be performed in a single component/device, or may be performed in a distributed manner (e.g., using multiple devices), such as when the query pre-processor 134 performs some or all pre-processing functions in a separate (e.g., upstream) device. Conversely, functionalities which are illustrated on multiple devices/elements may in fact be executed on a single device (e.g., the query resolver 166, or at least some functions thereof, may be executed on the computing device 132 illustrated as being associated with the producer node 122. Moreover, certain elements which, by themselves, are known in the art (such as, e.g., a compiler of the distributor node 120 for compiling results from two or more producer nodes 122, 126, 128 into the compiled results 108), are not explicitly illustrated in FIG. 1A for the sake of clarity and conciseness. Thus, still other implementations of the system 100, using such known components along with some or all of the illustrated components (and variations thereof) would be apparent to one of skill in the art.

FIG. 1B is a flowchart 100 illustrating example operations of the system of FIG. 1A. As shown, operations of the flowchart 100 are illustrated and labeled identically with corresponding reference numerals in FIG. 1A, for the sake of clarity and understanding.

Thus, in FIGS. 1A and 1B, the query 106 is received from the user 104 (144), e.g., at the distributor node 118. The distributor node 118 forwards the query 106 to the distributor 120 (146), which, in turn, forwards the query 106 to the producer node 122 (148). In particular, as described above, it is assumed for the example(s) herein that the distributor 120 is aware that the producer node 122 is thought to contain the most-accessed, most-desirable, most easily-accessed, smallest, and/or freshest results for the query 106 within the architecture 102. Consequently, all such queries may be passed first and immediately to the producer node 122.

Upon receipt thereof, the producer node 122 may begin pre-processing of the query 106 (149, 150), e.g., using the query pre-processor 134. That is, as described, the query pre-processor 134 may analyze the query features associated with the query 106 and the query pre-processor 134 to obtain a query representation for use in accessing the index of the data source 124 (149). At the same time and/or as part of the same process(ing), the query pre-processor 134 may analyze the query features and output a same or different query representation used by the query classifier 142 in conjunction with the classification data 138 and the classification model of the classification manager 140 to provide the query classification (150). Then, the producer node 122 forwards the query classification to the distributor node 120 (151) to thereby provide a prediction regarding the likelihood of productivity of accessing one or more of the other producer node(s) 126, 129.

It may be observed from this description that the producer node 122, e.g., the query classifier 142, is configured to send the prediction of the query classification to the distributor node 120 prior to, and/or in conjunction with, pre-processing of the query 106 for accessing the index of the data source 124, and prior to an actual resolution of the query 106 with respect to the data source 124 (152). In other words, as shown, such a query resolution (152) may proceed essentially in parallel with an operation of the distributor node 120 in forwarding the query 106 to the producer node(s) 126, 129. As a result, it may be observed that there is no need to wait for actual results obtained from the data source 124 for the distributor node 120 to make a forwarding decision(s) with respect to the query 106, so that, e.g., a response time of the architecture 102 may be improved for the query 106, along with a quality of the compiled results 108.

Further in FIG. 1B, then, the producer node 122 may complete the resolution of the query 106 against the data source 124 (152) and provide the results thereof to the distributor node 120 (154). As just described, these operations may be in parallel with, e.g., may overlap, the forwarding of the query 106 to the producer node 126 (156), and the subsequent resolving of the query 106 by the producer node 126 against the data source 128 (158) that is naturally followed by the producer 126 forwarding the results of the data source 128 to the distributor 120 (160).

Once results are received from at least the two producer nodes 122, 126 of the example of FIG. 1B, the distributor 120 may merge the results into the compiled results 108 for forwarding to the distributor 118 (162) and ultimate forwarding to the user 104 (164).

In FIG. 1B, an example(s) is given in which the query classifier 142 outputs a positive prediction with respect to a productivity of the producer node(s) 126, as shown by the subsequent forwarding of the query 106 to the producer node 126. The prediction is shown to be correct, inasmuch as the compiled results 108 do, in fact, include the result 114 from the data source 128 within the results 110, 112, 116 from the data source 124.

In other examples, of course, the prediction may be negative (e.g., a strong expectation that the other producer node(s) may not provide any productive results). In such cases, the distributor node 120 may be configured with a default behavior to not forward the query 106 beyond the producer node 122, unless affirmatively provided with at least a nominally positive prediction regarding an expected productivity of at least one other producer node, in which case the query classifier 142 may not need to forward any classification/prediction to the distributor node 120.

In other examples, it may occur as in FIG. 1A that there are a number of possible other producer nodes 126, 129 to which the query 106 might be forwarded. In this situation, the query classifier 142 may classify the query 106 as being predicted to yield productive results for only some of the available producer nodes (e.g., predicted to yield productive results from the producer node 126 but not the producer node 129). In this case and similar scenarios, the producer node 122 may forward the query classification along with an identification of at least one other producer node as a target node to which to forward the query 106. In other words, e.g., the classification manager 140 and the monitor 136, and thus the query classifier 142, may perform respective functions based on independent analyses of the different available, relevant producer nodes 126, 129, so that a resulting classification/prediction may be different for the same query 106 with respect to different available producer nodes.

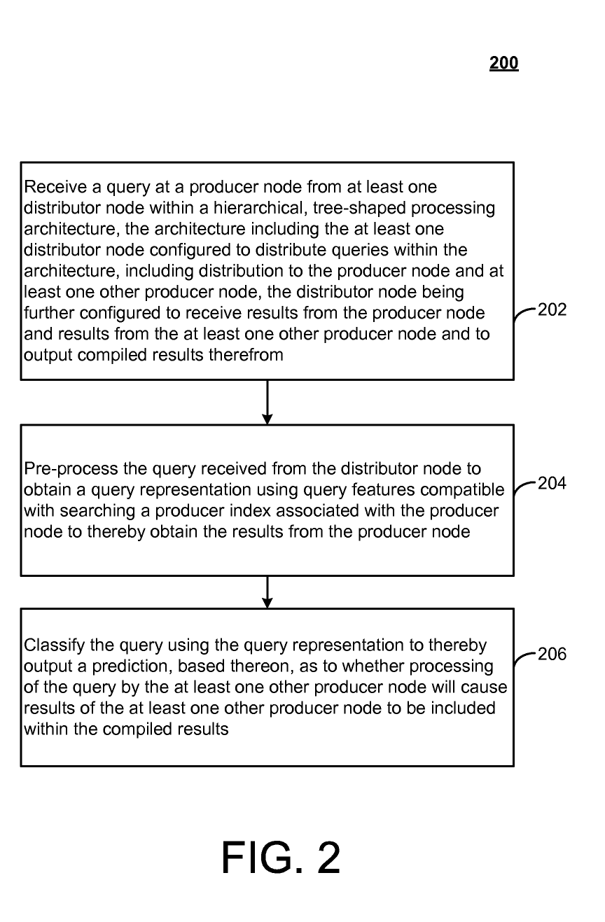

FIG. 2 is a flowchart 200 illustrating example operations of the producer node 122 of FIG. 1A. In FIG. 2, operations 202, 204, 206 are illustrated which provide the example operations as a series of discrete, linear operations. It may be appreciated, however, that the example operations may, in fact, overlap and/or proceed partially in parallel, or may occur in a different order than illustrated in FIG. 2 (to the extent that a particular order is not otherwise required herein). Further, additional or alternative operations may be included that may not be explicitly illustrated in FIG. 2.

In FIG. 2, then, the operations include receiving (202) a query at a producer node from at least one distributor node within a hierarchical, tree-shaped processing architecture, the architecture including the at least one distributor node configured to distribute queries within the architecture, including distribution to the producer node and at least one other producer node, the distributor node being further configured to receive results from the producer node and results from the at least one other producer node and to output compiled results therefrom. For example, as described in detail with respect to FIGS. 1A and 1B, the query 106 may be received at the producer node 122 from the distributor node 120 of the architecture 102, where the distributor node 120 is configured to distribute queries within the architecture 102, including distribution to the producer nodes 122, 126, 129, as shown, and to receive results from at least two of these and provide the compiled results 108 therefrom.

The operations may further include pre-processing (204) the query received from the distributor node to obtain a query representation using query features compatible with searching a producer index associated with the producer node to thereby obtain the results from the producer node. For example, the query pre-processor 134 may use certain query features as described above, relative to actual values of such features within the particular query 106, to prepare the query 106 for processing against the index of the data source 124. At the same time, the query pre-processor 134 may use the same query features (e.g., a same or different subset thereof) to construct a query representation, which may thus be the same or different query representation used to access the index of the data source 124.

Finally in FIG. 2, operations may include classifying (206) the query using the query representation to thereby output a prediction, based thereon, as to whether processing of the query by the at least one other producer node will cause results of the at least one other producer node to be included within the compiled results. For example, the query classifier 142 may be configured to input the query representation along with particular associated values of the query 106, and to input the classification model from the classification manager 140 and monitor 136, and corresponding classification data 138, and thereby output a classification of the query 106 that serves as a prediction to the distributor node 120. As described, the prediction provides an indication as to a likelihood and/or extent to which the query 106 will provide productive results if forwarded to the at least one other producer node 126.

Thus, FIG. 2 illustrates some example, basic operations of the producer node 122. As already described, many additional or alternative variations are possible. For example, it may be appreciated that the architecture 102 may be considerable larger and/or more complex than shown in FIG. 1A. For example, additional producer nodes may be in communication with the distributor nodes 118, 120, and/or more distributor nodes may be included than illustrated in this example(s).

Further, in FIG. 1A, only the producer node 122 is illustrated as including the query classification/prediction functionality described herein. However, it may occur that two or more of the producer nodes of the architecture 102 may include some or all of such functionality, or variations thereof. Such features may provide benefit since, for example, each producer node may have information available locally that is easily obtainable by the producer node in question but that would be more difficult or costly for other elements (distributor nodes or producer nodes) of the architecture 102 to obtain. In other examples, different classification models may be implemented within different parts of the architecture 102, in order to provide the most customized and optimized predictions.

FIG. 3 is a flowchart 300 illustrating additional example operations of the classification manager 140 of the system of FIG. 1A. More specifically, in FIG. 3, the classification manager 140 is illustrated as executing a supervised machine learning (SML) technique(s), which generally represent a way to reason from external instances to produce general hypotheses, e.g., to reason from past distributions of queries to the producer node(s) 126, 129 to obtain a general prediction about whether a current or future query distributed to the producer node(s) 126, 129 will be productive with respect to the compiled results 108.

In FIG. 3, query features are determined (302). For example, the classification manager 140 may communicate with the query pre-processor and/or with classification data 138 to identify all possible query features used by the query-preprocessor 134 that may be useful in constructing the classification model.

Then, for these query features, values may be determined (304). For example, the monitor 136 may send (or trigger to be sent) a set of queries (e.g., 1000 queries) to the producer node 126 (and/or the producer node 129). Then, results of these queries from the data source 128 (and/or the data source 130) may be tracked and measured by the monitor 136, and values for the query features may be stored, e.g., in the classification data 138. For example, if a query feature includes a number of terms in a query, then the monitor 136 may determine an actual count of terms of a query as a value of that query feature. Similarly, if query features include scores assigned to certain phrases or other query structures, then actual values for such scores for each query may be obtained and stored.

Then, a training data set may be defined (306). For example, the classification manager 140 may select a subset of query features and corresponding values, as well as corresponding query results obtained from the producer node(s) 126, 129 for the query/query features. It may be appreciated that different subsets of query features and query values may be selected during different iterations of the operations 300, for relating to the corresponding query results. In some cases, a relatively small number of query features/values may be used, which has the advantage of being light-weight and easy to compute and track. In other cases, a larger number may be used, and may provide more accurate or comprehensive classification results.

A classification algorithm may be selected (308). A number of such classification algorithms exist and may be selected here as need. As described, the criteria for a success or utility of a classification algorithm (and resulting classification model) is whether such an algorithm/model is, in fact, successful in predicting whether passing the query 106 to the producer node(s) 126, 129 will be productive with respect to the compiled results 108. However, additional or alternative criteria may exist.

For example, as described in more detail below, it will be appreciated that the classification manager 140, and ultimately the query classifier 142, is/are capable of making mistakes, e.g., inaccurate predictions. That is, the query classifier 142 may, for example, predict that the query 106 should be sent to the producer node 126, when, in fact, sending of the query 106 to the producer node 126 is not productive with respect to the compiled results 108. On the other hand, the query classifier 142 may, for example, predict that the query 106 should not be sent to the producer node 126, when, in fact, sending of the query 106 to the producer node 126 would have been productive with respect to the compiled results 108.

In the former case, the cost of the mistake of sending the query 106 just to obtain non-productive results is a loss of network resources that were used fruitlessly to communicate with the producer node 126 unnecessarily, which is similar to existing systems (except with less delay since the query 106 is processed in parallel at the producer nodes 122, 126, as described). On the other hand, the mistake of not sending the query 106 when productive results would have been obtained is potentially more problematic. Such a mistake is referred to herein as a loss, and results in the user being deprived of useful results that otherwise would have been provided to the user.

Thus, a classification algorithm may be selected which attempts to maximize the sending of productive queries, while minimizing lost queries/results. Again, examples of such classification algorithms are generally well-known and are therefore not discussed here in detail. Such examples may include, e.g., a decision tree algorithm in which query results are sorted based on query feature values, so that nodes of the decision tree represent a feature in a query result that is being classified, and branches of the tree represent a value that the node may assume. Then, results may be classified by traversing the decision tree from the root node through the tree and sorting the nodes using their respective values. Decision trees may then be translated into a set of classification rules (which may ultimately form the classification model), e.g., by creating a rule for each path from the root node(s) to the corresponding leaf node(s).

Other classification algorithms exist, and other techniques for inducing results therefrom are known. For example, single-layer or multi-layer perceptron techniques may be used, as well as neural networks, statistical learning algorithms (e.g., Bayesian networks), instance-based learning, and/or support vector machines. Again, one or more of these or other algorithms may be selected and tested, and ultimately implemented based on their success in predicting productive results and/or their success in avoiding lost results.

Once a classification algorithm is selected, a corresponding training dataset may be evaluated (310). For example, the classification manager 140 may be configured to implement the classification algorithm using a selected training dataset (subset) of the query features, query values, and corresponding query results. For example, a first training dataset may correspond to results of the query with respect to the producer node 1226 and a second with respect to the producer node 129. Further, different training sets may be tested for each producer node in different iterations of the process 300.

If results are satisfactory (312), then they may be formalized as the classification model and passed to the query classifier 142, as shown, for use in evaluating current and future queries. Otherwise, as shown, any of the operations 302-310 may be selected and varied in order to re-run the operations of the flowchart 300 to thereby obtain satisfactory results (312).

As referenced above, the operations 300 may be executed at an initial point in time to formulate an initial classification model. Then, the query classifier 142 may implement the classification model accordingly for a period of time. Over time, however, it may occur that the classification model becomes out-dated and less effective in classifying incoming queries.

To avoid this situation, the monitor 136 may periodically trigger the producer node(s) 126, 129 and then test the results therefrom and/or update the classification model accordingly. That is, for example, the monitor 136 may send queries to the producer node 126 regardless of whether the query classifier predicts productive results therefrom. Then, the classification manager 140 may compare the results against the predicted results to determine whether the classification model remains satisfactory or needs to be updated.

FIGS. 4A-4C are tables illustrating classification data used to construct a classification model. In FIG. 4A, it is assumed that two features are considered (e.g., as determined by the query pre-processor 134), query feature 1 402 and query feature 2 404. A third query feature, query feature 3 406, is illustrated as being present but not considered for the particular training dataset being tested. A shown, the query feature 402 may have value of either A or B, while the query feature 404 may have value of C or D.

Then, a total of 1000 queries may be sent to, e.g., the producer node 126. In this case, columns 408, 410 track results of doing so. For example, a first query of the 1000 queries may be sent to the producer node 126 and if a productive result is obtained then the result is counted once within the column 408, indicating that the query should be (should have been) sent. On the other hand, if a second query is sent with the query features AC and a non-productive result is reached, then the result is counted once within the column 410, indicating that the query should be (should have been) dropped.

The sending of the 1000 queries may thus continue and the results may be tracked accordingly until the columns 408, 410 are filled. Then, a decision regarding future actions to be taken on a newly-received query may be made.

For example, for the query feature combination (query representation) AC, it is observed that 87 results indicated a send, while 45 results indicated a drop. Consequently, a decision may be made that a future query having features AC should be sent, as shown in column 412. Similarly, for the query features BD, 92 “should send” results and 28 “should drop” results indicate that future instances of such queries should be sent. Conversely, for the query features AD, 20 “should send” results and 198 “should drop” results indicate that future instances of such queries should be dropped.

In the case of queries having features BC, 224 queries are indicated as “should send,” while 307 are indicated as being “should drop.” Consequently, it may not be apparent which action should be taken for future queries.

In further analysis in FIG. 4B, the 1000 queries are sent with features BC, and it is observed in a column 414 that if such queries are all sent, 403 should, in fact, have been sent (because productive results were obtained), while in a column 416 it is observed that when such queries are sent, 380 should in fact have been dropped. Conversely, when dropped, column 414 indicates 20 queries that should have been sent, and 198 that should have been dropped.

Thus, the 20 queries that should have been sent but were not, represent lost queries which denied productive results to the user 104. On the other hand, the 198 queries represent queries that were dropped and should have been dropped (i.e., would not have yielded productive results, anyway), and therefore represent a savings in network traffic and resources. Thus, 2% of productive queries are lost in order to save 19.8% of network traffic.

A similar analysis applies to FIG. 4C, in which the results are contemplated for the effect of dropping the 1000 queries with query features BC. There, it may be observed from columns 418, 420 that 244 results (24.4%) which are productive are dropped and therefore lost, while 505 (50.5%) are correctly dropped (and a corresponding amount of network traffic is conserved).

FIG. 5 is a block diagram of example computing environments in which the system of FIG. 1A may operate. More specifically, FIG. 5 is a block diagram showing example or representative computing devices and associated elements that may be used to implement the system of FIG. 1A.

Specifically, FIG. 5 shows an example of a generic computer device 500 and a generic mobile computer device 550, which may be used with the techniques described here. Computing device 500 is intended to represent various forms of digital computers, such as laptops, desktops, workstations, personal digital assistants, servers, blade servers, mainframes, and other appropriate computers. Computing device 550 is intended to represent various forms of mobile devices, such as personal digital assistants, cellular telephones, smart phones, and other similar computing devices. The components shown here, their connections and relationships, and their functions, are meant to be exemplary only, and are not meant to limit implementations of the inventions described and/or claimed in this document.

Computing device 500 includes a processor 502, memory 504, a storage device 506, a high-speed interface 508 connecting to memory 504 and high-speed expansion ports 510, and a low speed interface 512 connecting to low speed bus 514 and storage device 506. Each of the components 502, 504, 506, 508, 510, and 512, are interconnected using various busses, and may be mounted on a common motherboard or in other manners as appropriate. The processor 502 can process instructions for execution within the computing device 500, including instructions stored in the memory 504 or on the storage device 506 to display graphical information for a GUI on an external input/output device, such as display 516 coupled to high speed interface 508. In other implementations, multiple processors and/or multiple buses may be used, as appropriate, along with multiple memories and types of memory. Also, multiple computing devices 500 may be connected, with each device providing portions of the necessary operations (e.g., as a server bank, a group of blade servers, or a multi-processor system).

The memory 504 stores information within the computing device 500. In one implementation, the memory 504 is a volatile memory unit or units. In another implementation, the memory 504 is a non-volatile memory unit or units. The memory 504 may also be another form of computer-readable medium, such as a magnetic or optical disk.

The storage device 506 is capable of providing mass storage for the computing device 500. In one implementation, the storage device 506 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 504, the storage device 506, or memory on processor 502.

The high speed controller 508 manages bandwidth-intensive operations for the computing device 500, while the low speed controller 512 manages lower bandwidth-intensive operations. Such allocation of functions is exemplary only. In one implementation, the high-speed controller 508 is coupled to memory 504, display 516 (e.g., through a graphics processor or accelerator), and to high-speed expansion ports 510, which may accept various expansion cards (not shown). In the implementation, low-speed controller 512 is coupled to storage device 506 and low-speed expansion port 514. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 500 may be implemented in a number of different forms, as shown in the figure. For example, it may be implemented as a standard server 520, or multiple times in a group of such servers. It may also be implemented as part of a rack server system 524. In addition, it may be implemented in a personal computer such as a laptop computer 522. Alternatively, components from computing device 500 may be combined with other components in a mobile device (not shown), such as device 550. Each of such devices may contain one or more of computing device 500, 550, and an entire system may be made up of multiple computing devices 500, 550 communicating with each other.

Computing device 550 includes a processor 552, memory 564, an input/output device such as a display 554, a communication interface 566, and a transceiver 568, among other components. The device 550 may also be provided with a storage device, such as a microdrive or other device, to provide additional storage. Each of the components 550, 552, 564, 554, 566, and 568, are interconnected using various buses, and several of the components may be mounted on a common motherboard or in other manners as appropriate.

The processor 552 can execute instructions within the computing device 550, including instructions stored in the memory 564. The processor may be implemented as a chipset of chips that include separate and multiple analog and digital processors. The processor may provide, for example, for coordination of the other components of the device 550, such as control of user interfaces, applications run by device 550, and wireless communication by device 550.

Processor 552 may communicate with a user through control interface 558 and display interface 556 coupled to a display 554. The display 554 may be, for example, a TFT LCD (Thin-Film-Transistor Liquid Crystal Display) or an OLED (Organic Light Emitting Diode) display, or other appropriate display technology. The display interface 556 may comprise appropriate circuitry for driving the display 554 to present graphical and other information to a user. The control interface 558 may receive commands from a user and convert them for submission to the processor 552. In addition, an external interface 562 may be provide in communication with processor 552, so as to enable near area communication of device 550 with other devices. External interface 562 may provide, for example, for wired communication in some implementations, or for wireless communication in other implementations, and multiple interfaces may also be used.

The memory 564 stores information within the computing device 550. The memory 564 can be implemented as one or more of a computer-readable medium or media, a volatile memory unit or units, or a non-volatile memory unit or units. Expansion memory 574 may also be provided and connected to device 550 through expansion interface 572, which may include, for example, a SIMM (Single In Line Memory Module) card interface. Such expansion memory 574 may provide extra storage space for device 550, or may also store applications or other information for device 550. Specifically, expansion memory 574 may include instructions to carry out or supplement the processes described above, and may include secure information also. Thus, for example, expansion memory 574 may be provide as a security module for device 550, and may be programmed with instructions that permit secure use of device 550. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 564, expansion memory 574, or memory on processor 552, that may be received, for example, over transceiver 568 or external interface 562.

Device 550 may communicate wirelessly through communication interface 566, which may include digital signal processing circuitry where necessary. Communication interface 566 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 568. In addition, short-range communication may occur, such as using a Bluetooth, WiFi, or other such transceiver (not shown). In addition, GPS (Global Positioning System) receiver module 570 may provide additional navigation- and location-related wireless data to device 550, which may be used as appropriate by applications running on device 550.

Device 550 may also communicate audibly using audio codec 560, which may receive spoken information from a user and convert it to usable digital information. Audio codec 560 may likewise generate audible sound for a user, such as through a speaker, e.g., in a handset of device 550. Such sound may include sound from voice telephone calls, may include recorded sound (e.g., voice messages, music files, etc.) and may also include sound generated by applications operating on device 550.

The computing device 550 may be implemented in a number of different forms, as shown in the figure. For example, it may be implemented as a cellular telephone 580. It may also be implemented as part of a smart phone 582, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

In addition, any logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

It will be appreciated that the above embodiments that have been described in particular detail are merely example or possible embodiments, and that there are many other combinations, additions, or alternatives that may be included.

Also, the particular naming of the components, capitalization of terms, the attributes, data structures, or any other programming or structural aspect is not mandatory or significant, and the mechanisms that implement the invention or its features may have different names, formats, or protocols. Further, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead performed by a single component.

Some portions of above description present features in terms of algorithms and symbolic representations of operations on information. These algorithmic descriptions and representations may be used by those skilled in the data processing arts to most effectively convey the substance of their work to others skilled in the art. These operations, while described functionally or logically, are understood to be implemented by computer programs. Furthermore, it has also proven convenient at times, to refer to these arrangements of operations as modules or by functional names, without loss of generality.

Unless specifically stated otherwise as apparent from the above discussion, it is appreciated that throughout the description, discussions utilizing terms such as “processing” or “computing” or “calculating” or “determining” or “displaying” or “providing” or the like, refer to the action and processes of a computer system, or similar electronic computing device, that manipulates and transforms data represented as physical (electronic) quantities within the computer system memories or registers or other such information storage, transmission or display devices.

Certain aspects operations and instructions described herein in the form of an algorithm(s). It should be noted that the process operations and instructions may be embodied in software, firmware or hardware, and when embodied in software, may be downloaded to reside on and be operated from different platforms used by real time network operating systems.

An apparatus for performing the operations herein may be specially constructed for the required purposes, or it may comprise a general-purpose computer selectively activated or reconfigured by a computer program stored on a computer readable medium that can be accessed by the computer and that renders the general purpose computer as a special purpose computer designed to execute the describe operations, or similar operations. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

The algorithms and operations presented herein are not inherently related to any particular computer or other apparatus. Various general-purpose systems may also be used with programs in accordance with the teachings herein, or it may prove convenient to construct more specialized apparatus to perform the described operations, or similar operations. The structure for a variety of these systems will be apparent to those of skill in the art, along with equivalent variations. In addition, the present description is not described with reference to any particular programming language. It is appreciated that a variety of programming languages may be used to implement the teachings of the present descriptions, and any explicit or implicit references to specific languages are provided as examples.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the embodiments.

What is claimed is:

1. A computer system including instructions stored on a computer-readable medium, the computer system comprising:
a producer node of a hierarchical, tree-shaped processing architecture, the architecture including at least one distributor node configured to distribute queries within the architecture, including distribution to the producer node and at least one other producer node within a predefined subset of producer nodes, the distributor node being further configured to receive results from the producer node and results from the at least one other producer node and to output compiled results therefrom, the producer node including
a query pre-processor configured to process a query received from the distributor node to obtain a query representation using query features compatible with searching a producer index associated with the producer node to thereby obtain the results from the producer node; and
a query classifier configured to input the query representation and output a prediction, based thereon, as to whether processing of the query by the at least one other producer node within the predefined subset of producer nodes will cause results of the at least one other producer node to be included within the compiled results.

2. The system of claim 1 wherein the query classifier is configured to provide the prediction to the distributor node in conjunction with obtaining the query representation and before producing the results from the producer node, so that the producer node and the at least one other producer node provide their respective results to the distributor node in parallel.

3. The system of claim 1 wherein the query classifier is configured to determine the at least one other producer node from a plurality of other producer nodes within the architecture and to identify the at least one other producer node as a target node to which the query should be forwarded.

4. The system of claim 1 wherein the query classifier is configured to input at least two query features associated with the query representation and to compute the prediction based thereon.

5. The system of claim 4 wherein the query classifier is configured to select the at least two query features from a set of query features associated with the query representation.

6. The system of claim 4 wherein at least one of the at least two query features includes a term count of the terms within the query.

7. The system of claim 1 wherein the query classifier is configured to provide the prediction including a value within a range representing an extent to which the at least one other producer node is likely to be included within the compiled results.

8. The system of claim 1 wherein the query classifier is configured to provide the prediction including a value within a range representing an extent to which the at least one other producer should process the query for use in providing the results from the at least one other producer node.

9. The system of claim 1 wherein the producer node comprises a classification manager configured to input classification data including query features associated with the query representation, results from the at least one other producer node, and one of a plurality of machine learning algorithms, and configured to construct, based thereon, a classification model for output to the query classifier for use in outputting the prediction.

10. The system of claim 9 wherein the classification manager is configured to track the results from the at least one other node and to update the classification data and the classification model therewith.

11. The system of claim 9 wherein the producer node comprises a monitor configured to trigger the distributor node to periodically send a subset of the queries to the at least one other producer node whether indicated by the query classifier or not, and to update the classification data based thereon.

12. The system of claim 1 wherein the results from the producer node are obtained from a data source associated with the producer node using the producer index, and the results form the at least one other producer node are obtained form a data source associated with the at least one other producer node using a corresponding index, and wherein the at least one other producer node is less cost-effective to access when compared to the producer node.

13. A computer-implemented method in which at least one processor implements at least the following operations, the method comprising:
receiving a query at a producer node from at least one distributor node within a hierarchical, tree-shaped processing architecture, the architecture including the at least one distributor node configured to distribute queries within the architecture, including distribution to the producer node and at least one other producer node, the distributor node being further configured to receive results from the producer node and results from the at least one other producer node and to output compiled results therefrom;
pre-processing the query received from the distributor node to obtain a query representation using query features compatible with searching a producer index associated with the producer node to thereby obtain the results from the producer node; and
classifying the query using the query representation to thereby output a prediction, based thereon, as to whether processing of the query by the at least one other producer node will cause results of the at least one other producer node to be included within the compiled results.

14. The method of claim 13 wherein the classifying the query comprises:
providing the prediction to the distributor node in conjunction with obtaining the query representation and before producing the results from the producer node, so that the producer node and the at least one other producer node provide their respective results to the distributor node in parallel.

15. The method of claim 13 wherein the classifying the query comprises:
inputting classification data including query features associated with the query representation, results from the at least one other producer node, and one of a plurality of machine learning algorithms, and
constructing, based thereon, a classification model for use in outputting the prediction.

16. The method of claim 15 wherein the classifying the query comprises:
triggering the distributor node to periodically send a subset of the queries to the at least one other producer node whether indicated by the prediction or not, and to update the classification data based thereon.

17. A computer program product, the computer program product being tangibly embodied on a computer-readable medium and including executable code that, when executed, is configured to cause a data processing apparatus to:
receive a query at a producer node from at least one distributor node within a hierarchical, tree-shaped processing architecture, the architecture including the at least one distributor node configured to distribute queries within the architecture, including distribution to the producer node and at least one other producer node, the distributor node being further configured to receive results from the producer node and results from the at least one other producer node and to output compiled results therefrom;
pre-process the query received from the distributor node to obtain a query representation using query features compatible with searching a producer index associated with the producer node to thereby obtain the results from the producer node; and
classify the query using the query representation to thereby output a prediction, based thereon, as to whether processing of the query by the at least one other producer node will cause results of the at least one other producer node to be included within the compiled results.

18. The computer program product of claim 17 wherein, in classifying the query, the executed instructions cause the data processing apparatus to:
provide the prediction to the distributor node in conjunction with obtaining the query representation and before producing the results from the producer node, so that the producer node and the at least one other producer node provide their respective results to the distributor node in parallel.

19. The computer program product of claim 17 wherein, in classifying the query, the executed instructions cause the data processing apparatus to:
input classification data including query features associated with the query representation, results from the at least one other producer node, and one of a plurality of machine learning algorithms; and
construct, based thereon, a classification model for use in outputting the prediction.

20. The computer program product of claim 19 wherein, in classifying the query, the executed instructions cause the data processing apparatus to:
trigger the distributor node to periodically send a subset of the queries to the at least one other producer node whether indicated by the prediction or not; and
update the classification data based thereon.
